(19) United States
(12) Patent Application Publication
(10) Pub. No.: US 2019/0073645 A1
(43) Pub. Date: Mar. 7, 2019

(54) Systems and Methods of Decentralized Geospatial Data Gathering

(71) Applicant: ADVR, Inc., San Francisco, CA (US)

(72) Inventor: Arnaud Dazin, San Francisco, CA (US)

(21) Appl. No.: 15/696,082

(22) Filed: Sep. 5, 2017

(51) Int. Cl. G06Q 20/06; G06F 17/30; G06Q 20/40

(52) U.S. Cl. CPC G06Q 20/065; G06Q 20/401; G06F 17/30241

(57) ABSTRACT

The present invention relates to systems and methods for decentralized gathering of geospatial data in a cryptocurrency environment. Methods of incentivizing users to provide geospatial data, and incentivizing computing operators to process the data, are provided. The system comprises a node configured to receive a first instance of geospatial data from a first device and a second instance of geospatial data from a second device. The node further comprises executable code for comparing a first instance of geospatial data to a second instance of geospatial data, and based on the comparison, associating a unit of cryptocurrency with an identifier associated with the second instance of geospatial data.

### FIELD OF THE INVENTION

The field of the invention is implementations of blockchain using location and spatial data.

### BACKGROUND

The background description includes information that may be useful in understanding the present invention. It is not an admission that any of the information provided in this application is prior art or relevant to the presently claimed invention, or that any publication specifically or implicitly referenced is prior art.

Recent developments in digital currency have spawned large monetary investments. Bitcoin, a popular decentralized digital currency, has increased several thousand percent since the digital currency's inception, and early investors in Bitcoin have realized huge gains as a result of investment in Bitcoin.

In Bitcoin, digital currency is generated by solving difficult cryptographic problems. The solutions to these difficult cryptographic problems are difficult to find, but easy to verify. The difficult cryptographic problem is used to verify what is known in Bitcoin as a “blockchain,” which is a transactional record of all Bitcoins transferred using the service. New entries to the blockchain must be verified by a solution to the complex cryptographic problem.

To elaborate further, the Bitcoin system includes a number of nodes that all operate according to a protocol. All nodes share the block chain, i.e. the transaction database, which contains a record of all transactions made using the Bitcoin protocol. The “block chain” is a sequence of blocks, where each block contains information about a transaction and a cryptographic hash of all previous blocks. More particularly, a block includes a “magic number,” a block size, a block header, a transaction counter, and a list of nonempty list of transactions.

The “magic number” is used to identify data as Bitcoin data. The block size is used to identify the size of the block. The block header consists of six items: the block version number, the 256-bit hash of the previous block header, the 256-bit hash based on all transactions in the block, the current time in seconds since 1970-01-01T00:00 UTC, the “target, which is a number that all Bitcoin nodes share that adjusts the difficulty of the cryptographic problem, and a nonce, which is a sequence of bits that is adjusted until a solution to the cryptographic problem is arrived at.

The Bitcoin system requires solving complex cryptographic problems to verify new transactions, thereby adding to the block chain. Without an incentive to solve these cryptographic problems, which require computing power proportional to the difficulty adjusted by the “target,” Bitcoin would not work because no one would verify new transactions. Bitcoin protocol solves this problem by awarding Bitcoin to whomever solves the cryptographic problem necessary to verify new transactions.

In the Bitcoin system, older blocks become computationally impractical to modify because all blocks following them would need to be recomputed and, as mentioned above, the cryptographic hash is computationally difficult to solve (but easy to verify).

As a result of the Bitcoin-incentive system, Bitcoin adopters have invested in increased computing power necessary to solve the complex cryptographic problem presented by new Bitcoin transactions.

Another digital currency protocol is known as Ethereum. Ethereum is similar to Bitcoin, but includes a state transition system that is applied to the block chain. Ethereum conceptualizes Bitcoin as a state transition system, where a “state” consists of all existing bitcoins and a “state transition function” takes a state and a transaction and outputs a new state, which is the result. For a standard banking system, the state is a balance sheet. A transaction is a request to modify the balance sheet by moving an amount from one account to another. The state transition function reduces the value of a first account by the amount and increases the value of a second account by the same amount. If the first account does not contain a sufficient amount, the transaction returns an error.

One way to notate the transaction above is as follows: APPLY(S,TX)→S′ or ERROR. This notation means “apply transaction TX to state S to generate S′ or an error.” In the banking example described above, one example is the following: APPLY({First account: $100, Second account: $100},“move $30 from the first account to the second account”)={First account: $70, Second account: $130}.

Ethereum recognized that the Bitcoin ledger, from a technical standpoint, can be thought of as a state transition function. In Bitcoin, a “state” is consists of the ownership status of all existing coins. More particularly, it is the collection of all coins that have been mined and are available to spend. Each coin has a denomination and an owner, where the owner is defined by a 20-byte address that is essentially a cryptographic public key. More specifically, the public key is the hash of an elliptic curve public key, but for cryptographic purposes operates as a public key.

In Bitcoin, the state transition function would be defined as follows: for each input in the transaction, if the referenced unspent coin is not in the state, return an error; if the provided signature does not match the owner of the unspent coin, return an error. Then, if the sum of the denominations of all input unspent coins is less than the sum of the denominations of all output unspent coins, return an error (basically, verify that new money was not created as a result of a transaction). Then, return a new state with all input unspent coins removed and all output unspent coins added—that is, all now-spent coins are removed and all available-to-spend coins are added, their respective owners being different.

Bitcoin transactions are data structures that are propagated to Bitcoin nodes. If valid, the transaction is propagated to other nodes. The data structure contains a version, an input counter, inputs, an output counter, outputs, and “locktime.” Most of the time, locktime is set to 0 to indicate that a transaction is immediately valid. Other times, locktime may indicate a transaction is valid only after a specified time. Bitcoin users do not have an “account balance”; instead, they possess cryptographic keys that indicate that transaction outputs without a corresponding input in another transaction (i.e. unspent transaction outputs) belong to them. These unspent transaction outputs may be scattered across millions of different transactions.

Bitcoin transaction outputs consist of two parts, an amount and a “locking script.” The locking script is also known as an “encumbrance,” and it defines the conditions that must be satisfied before the transaction output can be spent. In most cases, the locking script is a series of mathematical operators that reference a cryptographic public key hash that, when paired with a key that would be present in an unlocking script, evaluates to “true.” Public key hashes are more commonly referred to as Bitcoin addresses.

To maintain the protocol as a decentralized service, a consensus system is necessary to ensure everyone agrees on the order of the transactions. Bitcoin's consensus process requires nodes in the network to continuously attempt to produce transaction packages. The Bitcoin network is intended to create one “block” of transaction packages every ten minutes, with each block containing a timestamp, a nonce, a hash of the previous block, and a list of all transactions that have occurred since the previous block. Over time, this creates the bitcoin block chain.

The following algorithm checks if a block is valid: (1) check if the previous block referenced by the block exists and is valid, (2) check that the timestamp of the block is greater than that of the previous block and less than 2 hours into the future, (3) check that the proof of work on the block is valid, (4) let S[0] be the state at the end of the previous block, (5) suppose TX is the block's transaction list with n transactions. For all i in 0 . . . n−1, set S[i+1]=APPLY(S[i],TX[i]). If any application returns an error, exit and return false, (6) return true, and register S[n] as the state at the end of the block.

One important aspect of Bitcoin is that it stores transactions using a Merkle tree protocol. A Bitcoin hash of a block actually contains only the hash of the block header, a 200-byte piece of data that contains the timestamp, nonce, previous block hash and the root hash of a Merkle tree storing all transactions in the block. Using a Merkle tree allows data to be downloaded piecemeal: a node can download only the header of a block from one source, then the small part of the tree relevant to them from another source, and be assured that all of the data is correct. This works because hashes propagate upward: swapping a fake transaction in for a real one would result in a change to every upward node, including the root.

At the same time, there exists a need for non-proprietary geospatial data and a system for incentivizing development of non-proprietary geospatial data. Products such as Google Streetview are prominent examples of proprietary geospatial data.

Expensive satellites also provide geolocation information about the world around us. This data is collected and reserved for use in private products. Streetview Maps require a heavy infrastructure, dedicated vehicles to gather photos of the world. Location and Geospatial data are core components in an ever-increasing amount of applications. Originally centralized around maps and directions, reliable data using the world around us has become central to services provided. Data about the physical world around us is becoming more contextually relevant than ever, in games, reviews, alerts, pathing for autonomous vehicles, and more. Current GPS technology is only accurate to within dozens of feet, and WiFi positioning systems are powerful but coarse in location information.

The present invention was developed to address the need to anchor digital content to a decentralized, always up-to-date, digital map. Locoin, an ERC20 token built on top of Ethereum, will be the unit of exchange in a new, decentralized, blockchain-based mapping platform that incentivizes users to contribute anonymized spatial mapping data.

The foregoing discussion of the Bitcoin protocol is for background purposes only; it is not an admission that any aspect of Bitcoin or the Bitcoin protocol is prior art.

### SUMMARY OF THE INVENTION

The present invention provides apparatus, systems, and of gathering geospatial data in a decentralized way.

In one aspect of the inventive subject matter, a decentralized cryptocurrency geospatial data system is contemplated. The system includes a node that is configured to receive from a first device a first instance of geospatial data and a first identifier, where the node is further configured to receive from a second device a second instance of geospatial data and a second identifier. The second device is configured to (i) capture a second instance of geospatial data, (ii) associate the second instance of geospatial data with a second identifier, (iii) transmit the second instance of the geospatial data and the second identifier to the node. The node includes executable code for comparing the second instance of geospatial data to geospatial data derived from the first instance of geospatial data, and, if the comparison validates the second instance of geospatial data, associating a unit of cryptocurrency with the second identifier.

In some embodiments, the node is further configured to validate a block, the block comprising a reference to a previous block, a timestamp, the first and second instances of geospatial data, a transaction, and a value representing a maximum number of computational steps to execute in a state transition function.

In some embodiments, the executable code is configured to carry out the following steps: (1) verifying the previous block referenced by the block to be added to a blockchain exists; (2) verifying the timestamp of the block is greater than that of the previous block; (3) verifying a cryptographic hash associated with the block satisfies predetermined criteria, where the predetermined criteria is defined such that average computation time required to compute the cryptographic hash exceeds a set time; and (4) performing the comparison of the second instance of geospatial data to the geospatial data derived from the first instance of geospatial data.

In some embodiments, the devices include both, or either, of a camera and device orientation hardware.

The comparison of the second instance of geospatial data to the first instance can include identifying a feature point and comparing the feature point to a feature point of the first instance of geospatial data. In some embodiments, the first instance of geospatial data is associated with an earlier block of the blockchain.

In another aspect of the inventive subject matter, a method of collecting and interpreting information about the physical world is contemplated. It includes the steps of: (1) collecting a first set of geospatial data from a first computing device controlled by a first user; (2) storing the first set of geospatial data; (3) collecting a second set of geospatial data from a second computing device controlled by a second user; (4) storing the second set of geospatial data; (5) comparing the second set of geospatial data to the first set of geospatial data to identify a feature; and (6) upon identifying a feature, rewarding an amount of a cryptocurrency to the second user. The amount of cryptocurrency that is awarded can be determined based on a quantity of successfully identified features.

In some embodiments, the step of comparing further comprises identifying whether to consider the feature as permanent.

It is contemplated that geospatial data can include one, or any combination, of: image information (which can include depth information), location information, and orientation information. Image information, for example, can be collected using at least one optical sensor that is coupled with a computing device.

The step of collecting geospatial data can include using at least one of: (1) at least one optical sensor that is coupled with the first computing device, and (2) at least one inertial measurement unit (IMU) that is coupled with the first computing device.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 depicts a device capturing a first image, geolocation, and orientation data.

FIG. 2 depicts a first device reporting geospatial data to a node.

FIG. 3 depicts a second device which captures an image, geolocation, and orientation data.

FIG. 4 depicts a second device reporting geospatial data to a node.

FIG. 5 depicts a system for comparing the information from the second device to the information from the first device.

FIG. 6 depicts a cryptocurrency reward for the contribution of geospatial data.

FIG. 7 depicts processing of raw geospatial data.

FIG. 8 depicts the process of adding geospatial data to the blockchain.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

The invention described in this application presents a system and method for a digital currency comprising a transaction, a block, a blockchain, and a mining function, wherein the mining function comprises a method for comparing a potential geospatial data point to a pre-existing geospatial data point. It is contemplated that embodiments of the inventive subject matter present systems and methods for cryptocurrency-based geospatial data collection.

In one embodiment, the system comprises accounts, messages, and transactions. An account comprises an address, as well as a nonce, a balance, and, optionally, a contract code and storage. The nonce is a counter to ensure each transaction can be processed only once. An account may optionally be an externally owned account or a contract account. In a contract account, receiving a message causes the contract code associated with the account to execute.

A transaction is data sent from an externally owned account. It comprises information about the recipient of a message, a signature identifying the sender, an amount of cryptocurrency to transfer from the sender to the recipient, an optional data field, a value representing the maximum number of computational steps the transaction execution is allowed to take, and a value representing a fee the sender pays per computational step. A transaction, when sent, causes the recipient of the transaction to execute the code associated with the account.

A message is data that is caused to be sent by the execution of contract code. A message comprises information about the sender of the message (implicit), the recipient of the message, an amount of cryptocurrency to transfer alongside the message, an optional data field, and a value representing a number of computational steps. A message, like a transaction, causes the recipient account to run the account's contract code.

Embodiments of the inventive subject matter also comprise at least one node. A node comprises software for executing a state transition function, which includes the following steps: (1) check if the transaction is well-formed, that the signature is valid, and that the nonce matches the nonce in the sender's account. If not, return an error. (2) Calculate the transaction fee. (3) Initialize a computational step counter. (4) Transfer the transaction value from the sender's account to the receiver's account. If the receiving account does not yet exist, create it. If the receiving account is a contract, run the contract's code either to completion or until the number of computational steps is exceeded. (5) If the value transfer failed because the sender lacked funds, or the code execution exceeded the maximum computational steps, revert all state changes except payment of fees. (6) If the value transfer failed for another reason, refund fees for all remaining computational steps to the sender, and send fees paid for computational steps consumed to the processor of computational steps.

Embodiments of the inventive subject matter further comprise a blockchain, which comprises at least one block. A block comprises a transaction state corresponding to the most recent transaction state and a transaction state transition. A node also comprises a validation algorithm for a block, which performs a process to verify that a state transition is valid. One node validation algorithm is: (1) check if the previous block referenced by the block exists and is valid, (2) check that the timestamp of the block is greater than that of the previous block and less than some amount of time (e.g., 0-1 hours, 2-3 hours, 3-4 hours, but preferably 2 hours) into the future, (3) check that the block number, difficulty, transaction root, uncle root, and gas limit are valid, (4) check that proof of work on the block is valid, (5) Let S[0] be the state at the end of the previous block. (6) Let TX be the block's transaction list, with n transactions. For all i in 0 . . . n−1, set S[i+1]=APPLY(S[i],TX[i]). If any application returns an error, or if the total computational steps consumed in the block up until this point exceeds the maximum number of computational steps, return an error. (7) Let S_FINAL be S[n], but adding the block reward paid to the miner. (8) Check if the Merkle tree root of the state S_FINAL is equal to the final state root provided in the block header. If it is, the block is valid; otherwise, it is not valid. The blockchain further comprises feature data that has achieved consensus, a process described further below.

Embodiments of the inventive subject matter further comprise a geospatial data gathering contract account, comprising a contract address and software code for comparing a first geospatial data point received from a first device and associated with a first identifier to a second geospatial data point received from a second device and associated with a second identifier and, if the first geospatial data point is sufficiently similar to the second geospatial data point, incrementing a value associated with verification of the first and second geospatial data points. If the value associated with verification exceeds a predetermined amount, it causes a unit of cryptocurrency to be sent to an account associated with the first identifier.

It is contemplated that the devices (e.g., the first and second devices) that are used to collect the geospatial data can be computing devices including cell phones, tablets, cameras, etc. Devices preferably include both at least one camera (e.g., optical, infrared, ultraviolet) and at least one inertial measurement unit (IMU). An IMU is an electronic device that can be configured to measure and report any combination of one or all of: force, angular rate, and magnetic field. To do this, IMUS can include: a combination of accelerometers, gyroscopes, and magnetometers. It is additionally contemplated that devices can also include GPS sensors to determine geolocation. It is also contemplated that a first device may obtain geospatial data indirectly from a third device that includes at least one camera and at least one IMU.

Thus, devices can detect and measure: location, spatial information, orientation information, and all other information that can be inferred directly or indirectly from those measured quantities. All or some of the information that is collected from a device (e.g., directly or indirectly) can be incorporated into the geospatial data that is contemplated in this application.

Thus, a first device can be enabled to communicate a first geospatial data point to a node. When the node performs a block validation, it causes executable code to run which compares the first geospatial data point to a second geospatial data point that is either stored in a contract's persistent storage or another persistent storage medium. If the executable code determines, based on the comparison, that the communicated first geospatial data point is valid, it causes.

In some embodiments of the inventive subject matter, it is contemplated that a first device is configured to gather a first instance of geospatial data and further configured to communicate the first instance of geospatial data and a first identifier associated with a first user of the first device to a remote computing device; a second device configured to gather a second instance of geospatial data and further configured to communicate the second instance of geospatial data, and a second identifier associated with a second user of the second device, to the remote computing device, wherein the computing device is configured to compare the first instance of geospatial data to the second instance of geospatial data, and, if the comparison result is valid, performing one or both of the following: (i) associating the first identifier and the second identifier with a counter or (ii) associating a first unit of a cryptocurrency with the first identifier.

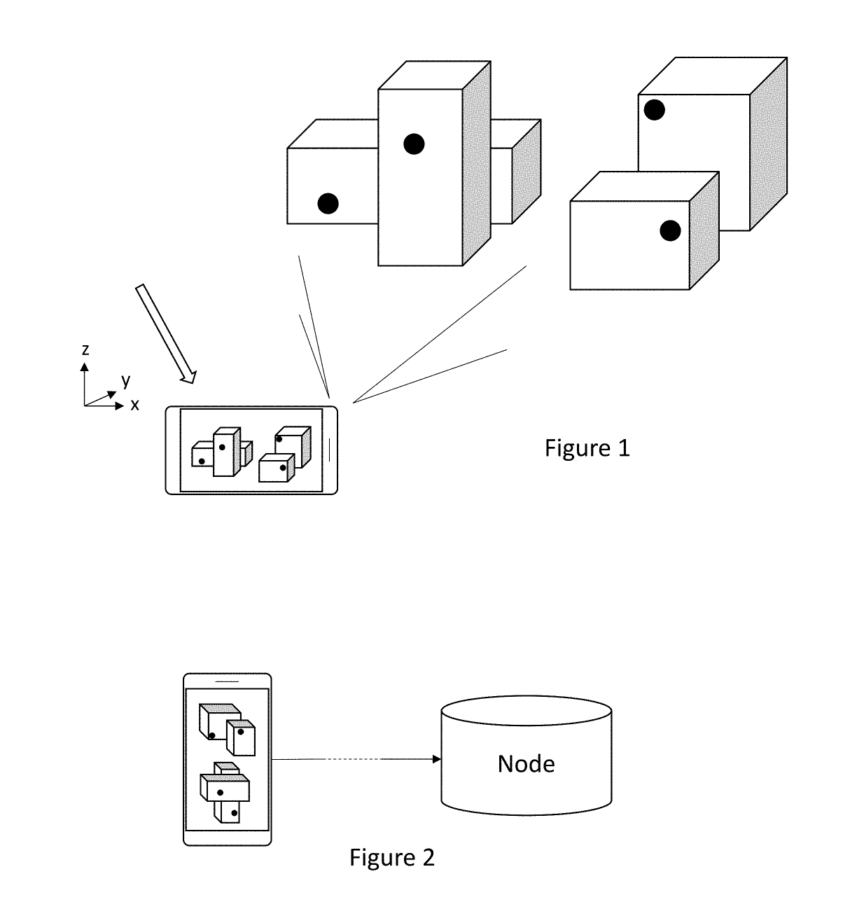

FIG. 1 depicts first device 101, which captures an instance of geospatial data. The geospatial data comprises an image comprising points in three-dimensional space, geolocation data, and device orientation. Device orientation is used to normalize the image, such that two images comprising points in three-dimensional space, taken at different orientations, may be compared. Normalization may be performed by either first device 101 or a node.

FIG. 2 depicts first device 101, which includes a communication device, e.g. WiFi antenna, Bluetooth antenna, or other wireless or wired transmission system, to communicate the first instance of geospatial data to a node.

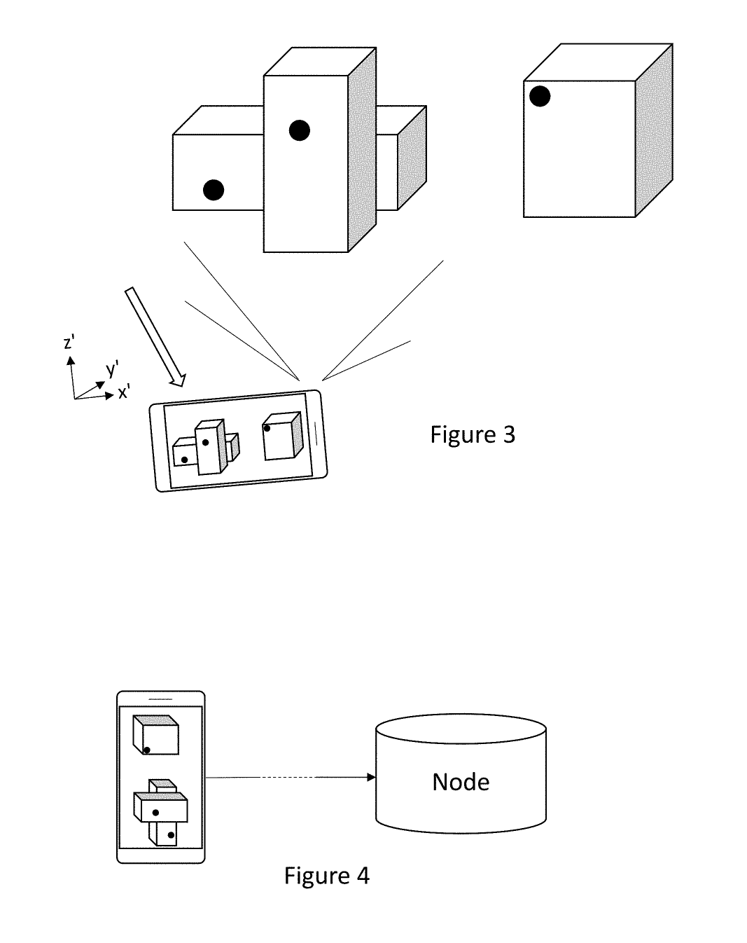

FIG. 3 depicts a second device 301, which captures a second instance of geospatial data comprising an image comprising points in three-dimensional space, geolocation data, and device orientation. It will be appreciated that geospatial data may, in some embodiments, comprise an image comprising points in two-dimensional space and geolocation data.

FIG. 4 depicts second device 301, which includes a communication device to communicate the second instance of geospatial data to the node.

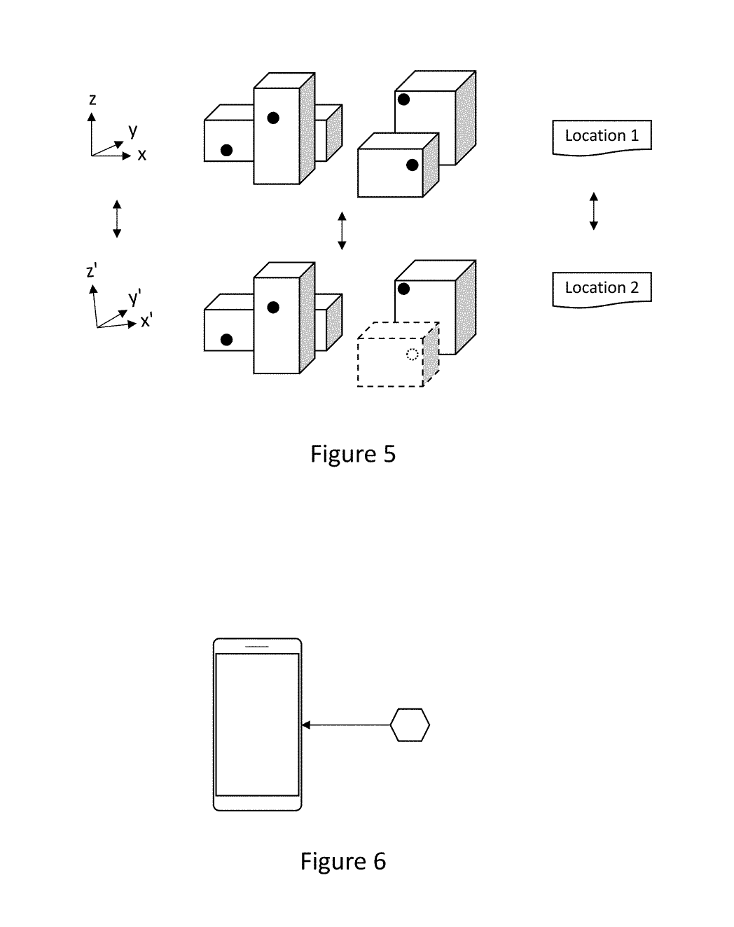

FIG. 5 depicts the process of comparing the second instance of geospatial data with the first instance of geospatial data. A consensus value is calculated based on a weighted function of frequency (e.g., how many devices have captured a feature) and freshness (e.g., how recent the captures were). The calculation of a consensus value may be part of the executable code for comparing instances of geospatial data. The comparison may be achieved by, for example, a permanence aware iterative closest point algorithm, which matches second instance of geospatial data to an other instance of geospatial data, where the second instance and the other instance are matched because they contain data concerning the same underlying features.

FIG. 6 depicts a reward of a unit of cryptocurrency, which is associated with an identifier provided by a device that has provided geospatial data that achieves consensus.

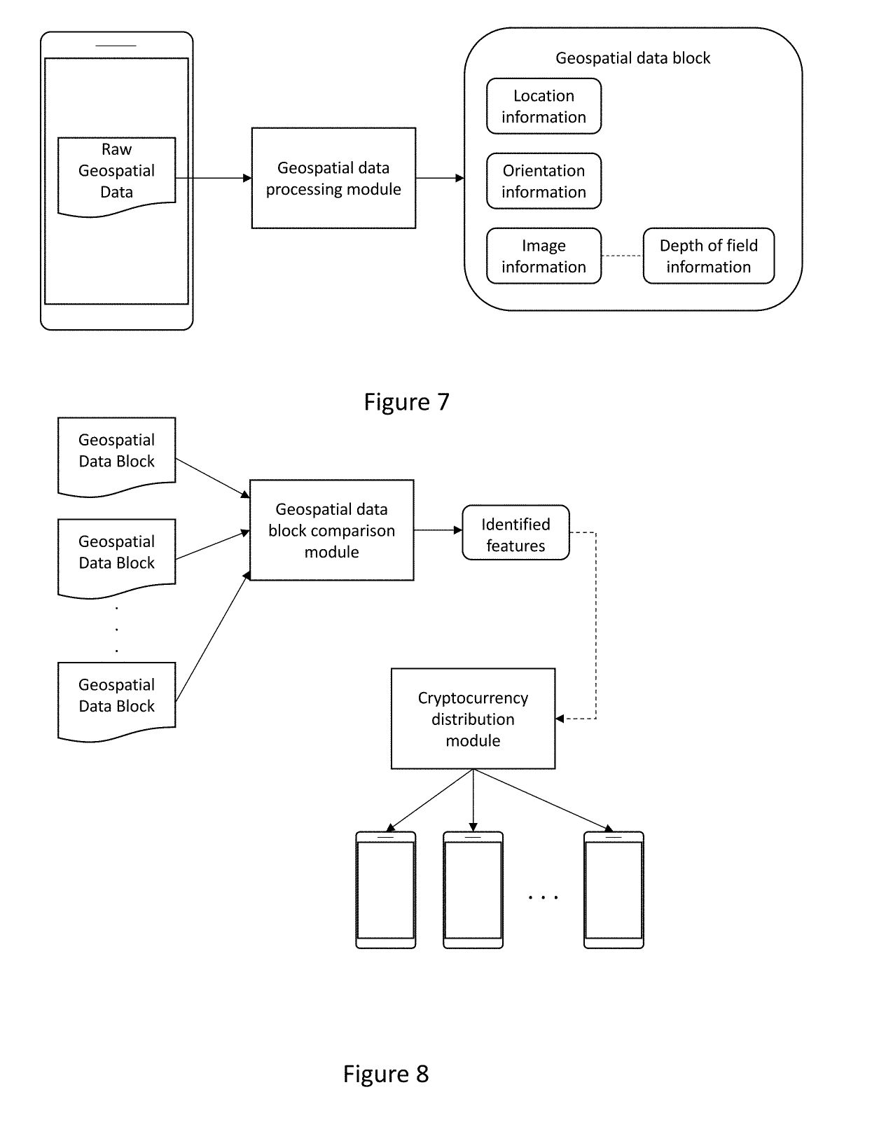

FIG. 7 depicts a process of gathering raw geospatial data 701. The raw geospatial data 701 is then communicated to a geospatial data processing module 702, e.g. a node as discussed above, another computing device, or a processor on the device that gathered raw geospatial data 701. The raw geospatial data 701 is processed into a geospatial data block 703, which comprises location information, orientation information, image information, and optionally depth of field information.

FIG. 8 depicts the processing of several geospatial data blocks by geospatial data block comparison module 801. As described above, geospatial data block comparison module may comprise, e.g. a node or several nodes for distributed computing, or another processor relied upon for accuracy by cryptocurrency nodes. Geospatial data block comparison module 801 identifies features 802 based on, e.g., a weighted function of how recent each geospatial data block is and how many times an identified feature is present in the geospatial data blocks. When consensus is achieved, cryptocurrency distribution module 803, which may comprise, e.g. account contract code, causes a unit of cryptocurrency to be associated with identifiers provided with geospatial data blocks.

Thus, specific compositions and methods of the invention have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

1. A decentralized cryptocurrency geospatial data system comprising:
a node, configured to receive from a first device a first instance of geospatial data and a first identifier;
wherein the node is further configured to receive from a second device a second instance of geospatial data and a second identifier;
wherein the second device is configured to (i) capture the second instance of geospatial data, wherein the second instance of geospatial data is collected by the first device and comprises a second location and a second orientation, (ii) associate the second instance of geospatial data with the second identifier, (iii) transmit the second instance of the geospatial data and the second identifier to the node; and
wherein the node is configured to process the first instance of geospatial data to create a first geospatial data block;
wherein the node is further configured to compare the second instance of geospatial data to the first geospatial data block, and, if the comparison validates the second instance of geospatial data, associate a unit of cryptocurrency with the second identifier.

2. The system of claim 1, wherein the node is further configured to validate a block to be added to a blockchain, the block comprising a reference to a previous block, a timestamp, the first and second instances of geospatial data, a transaction, and a value representing a maximum number of computational steps to execute in a state transition function.

3. The system of claim 2, wherein the node is further configured to:
verify the previous block referenced by the block to be added to the blockchain exists;
verify the timestamp of the block is greater than that of the previous block;
verify a cryptographic hash associated with the block satisfies a predetermined criteria, the predetermined criteria defined such that average computation time required to compute the cryptographic hash exceeds a set time; and
perform the comparison of the second instance of geospatial data to the first geospatial data block.

4. The system of claim 1, wherein the second device comprises a camera and device orientation hardware.

5. The system of claim 1, wherein the comparison of the second instance of geospatial data to the first geospatial data block comprises identifying a feature point and comparing the feature point to a feature point of the first geospatial data block.

6. The system of claim 3, wherein the first geospatial data block is associated with an earlier block of the blockchain.

7. A method of collecting and interpreting information about the physical world, comprising the steps of:
collecting a first set of geospatial data from a first computing device controlled by a first user;
storing the first set of geospatial data;
collecting a second set of geospatial data from a second computing device controlled by a second user;
storing the second set of geospatial data;
comparing the second set of geospatial data to the first set of geospatial data to identify a feature; and
upon identifying a feature, rewarding an amount of a cryptocurrency to the second user.

8. The method of claim 7, wherein the step of comparing further comprises identifying whether to consider the feature as permanent.

9. The method of claim 7, wherein the first and second sets of geospatial data comprise: image information, location information, and orientation information.

10. The method of claim 9, wherein the image information comprises depth information.

11. The method of claim 7, wherein the step of collecting the first set of geospatial data comprises using at least one of: (1) at least one optical sensor that is coupled with the first computing device, and (2) at least one inertial measurement unit (IMU) that is coupled with the first computing device.

12. The method of claim 7, wherein the step of collecting the second set of geospatial data comprises using at least one of: (1) at least one optical sensor that is coupled with the second computing device, and (2) at least one inertial measurement unit (IMU) that is coupled with the second computing device.

13. The method of claim 7, wherein the step of collecting the first set of geospatial data comprises using at least one optical sensor that is coupled with the first computing device.

14. The method of claim 7, wherein the amount of the cryptocurrency is determined based on a quantity of successfully identified features.
